(19) United States
(12) Patent Application Publication
(10) Pub. No.: US 2026/0144253 A1
(43) Pub. Date: May 28, 2026

(54) CLEANING AGENT COMPOSITION COMPRISING SOPHOROLIPID SURFACTANT AND AN ANTIMICROBIAL COMPOUND

(71) Applicant: HENKEL AG & CO. KGAA, Düsseldorf (DE)

(72) Inventors: Sami ABDALLAH, Dubai (AE); Nedjmah LECHEHEB, Dubai (AE); Hesham EISSA, Dubai (AE); Peter SCHMIEDEL, Düsseldorf (DE)

(21) Appl. No.: 19/121,023

(22) PCT Filed: Oct. 6, 2023
(86) PCT No.: PCT/EP2023/077782

§ 371 Date: Apr. 14, 2025

(30) Foreign Application Priority Data
Oct. 14, 2022 (EP) 10 2022 210 850.7

(51) Int. Cl. A01N 33/12; A01N 25/30; A01P 1/00; C11D 1/66; C11D 3/30

(52) U.S. Cl. CPC A01N 33/12; A01N 25/30; A01P 1/00; C11D 1/662; C11D 3/30

(57) ABSTRACT

A cleaning agent composition for cleaning hard surfaces includes a sophorolipid and an antimicrobial agent that comprises a quaternary ammonium compound. The sophorolipid and the quaternary ammonium compound show unexpected synergy.

The present invention relates to a cleaning agent composition and to a method for cleaning hard surfaces.

Continuously changing requirements are placed on the forms of manufacture and supply of cleaning agents. A trend relevant to the production of cleaning agents is their concentration. In addition to higher consumer acceptance due to simplified handling, the background of this development is, in particular, sustainability aspects, for example in relation to transport volumes and costs and the quantity of packaging materials used.

The concentration of modern cleaning agents, in particular modern liquid cleaning agents, generally influences their optical and rheological properties, has effects on the storage stability of these agents, and can influence their cleaning performance, in particular when the high concentration of the active substances leads to incompatibilities.

In addition, the concentration of cleaning agents generally involves the use of organic solvents. These solvents improve the physical stability of the cleaning agents, but are often characterized by only low cleaning activity, which is why they should be added in the smallest possible quantities, not least for sustainability reasons. However, the use of aqueous or aqueous-organic solvent systems in the production of concentrated liquid cleaning agents cannot yet be avoided with conventional cleaning-active agents.

Cleaning agents are known from patent application EP 0 499 434 A1 which contain a surfactant forming a micellar phase and another surfactant forming a lamellar phase, wherein at least one of these two surfactants must be a glycolipid biosurfactant, in particular a rhamnolipid, glucose lipid, sophorose lipid, trehalose lipid and/or cellobiose lipid. European patent application EP 1 445 302 A1 relates to cleaning agents containing at least one glycolipid biosurfactant, in particular sophorolipid and/or rhamnolipid, and at least one non-glycolipid surfactant, these surfactants being in a micellar phase. Liquid aqueous cleaning agents are known from European patent application EP 3 686 265 A1 which contain anionic surfactant of the sulfate or sulfonate type, soap, nonionic surfactant, enzyme and sophorolipid. European patent application EP 3 290 501 A1 relates to agents containing alkoxylated fatty acid amide and a glycolipid biosurfactant, which can be a sophorolipid.

Against this background, the present invention was based on the object of providing cleaning-active substances that allow the production of visually appealing, concentrated flowable disinfectant cleaning agent preparations. The active ingredients should be producible in a simple and efficient manner, have good storability, and be characterized in particular by good cleaning results.

This object was achieved by a cleaning agent composition for cleaning hard surfaces, comprising:
a sophorolipid; and
an antimicrobial agent that comprises a quaternary ammonium compound,
wherein the quaternary ammonium compound has the general formula (I):

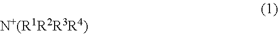

wherein the quaternary ammonium compound of formula (I) has:
   two functional groups having a C-chain length of at most 4, in particular of 1,
   a functional group having a C₈ to C₁₈ carbon chain,
   a functional group having a benzyl group; or
wherein the quaternary ammonium compound of formula (I) has:
   two functional groups having a C-chain length of at most 4, in particular of 1,
   two functional groups having a C8 to C18 carbon chain, in particular a C12 carbon chain.

According to a preferred embodiment, a cleaning agent composition is described wherein the antimicrobial agent is benzalkonium chloride.

According to a preferred embodiment, a cleaning agent composition is described wherein the antimicrobial agent is didecyldimethylammonium chloride.

Surprisingly, it was found that the combination of sophorolipids and quaternary antimicrobial compounds can synergistically enhance the cleaning performance of sophorolipids. Advantageously, no sparingly soluble or insoluble precipitates are formed in the process.

Sophorolipids consist of a sophorose functional group in which two glucose molecules are β-1,2′-glycosidically linked, to which glucose molecules a hydroxyl group of a hydroxycarboxylic acid β-glycosidically bonded. The hydroxycarboxylic acid can bear the hydroxyl group on the terminal C atom or on a C atom located within the carbon chain and can be saturated or unsaturated. Examples of sophorolipids are:

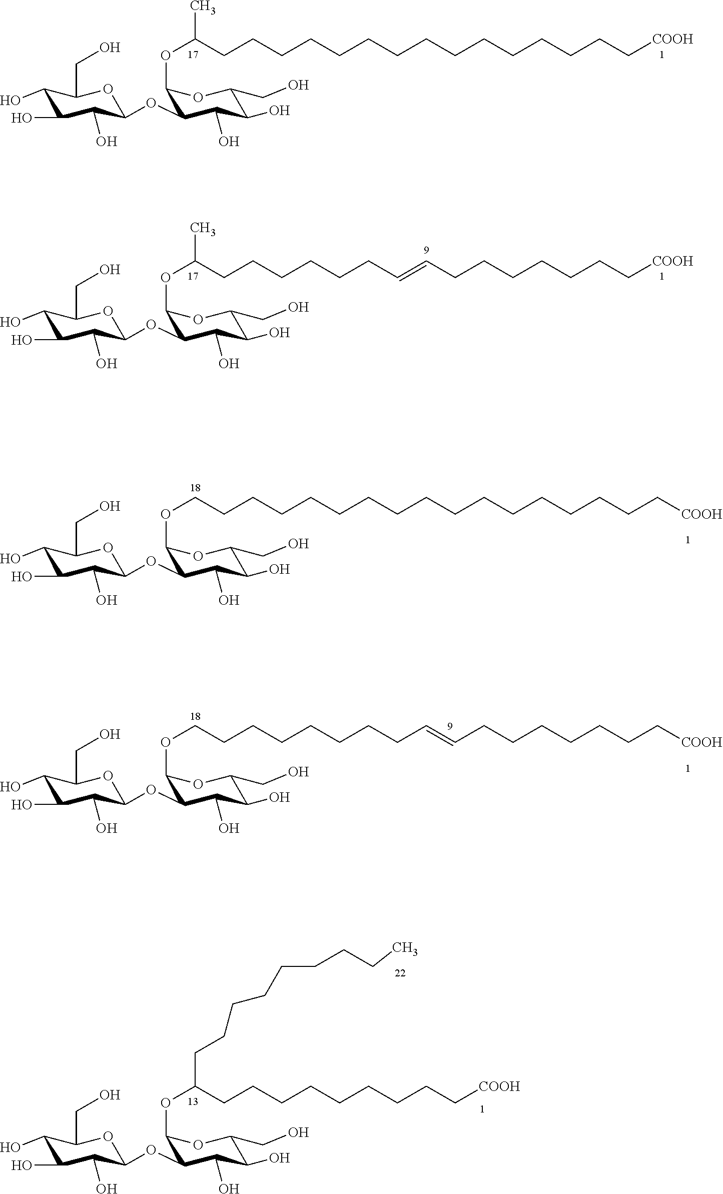

They can be in the open form, shown above as an example, or in the form of monomeric or dimeric lactones, for instance:

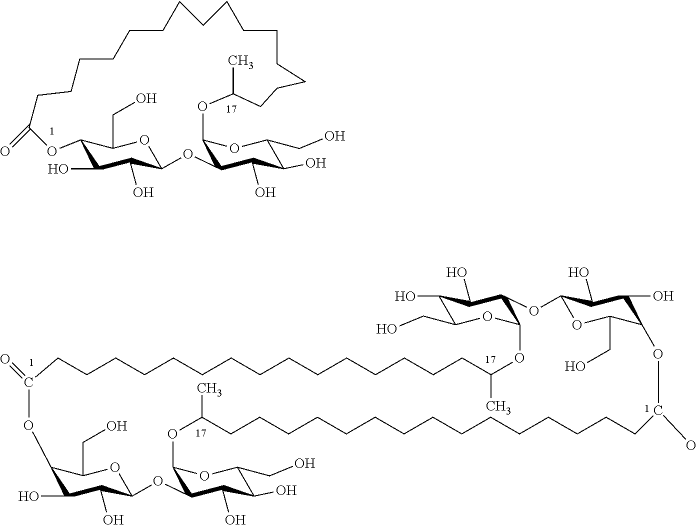

The open form and the lactone form can also exist alongside one another, and can both be converted into one another by intramolecular esterification or hydrolysis. In the compounds of formula (I), the sophorolipids are present in the open form. The hydroxyl groups located on the sophorose functional groups of the sophorolipids can also be esterified, either completely or partially, with carboxylic acids, with acetic acid being an example of a possible carboxylic acid, and the primary hydroxyl groups being the most common esterification points. Sophorolipids are produced, for example, by yeasts such as Candida albicans, Candida apicola, Candida floricola, Candida kuoi, Candida riodocensis, Candida stellata, Candida tropicalis, Candida parapsilosis, Rhodotorula bajevae, Rhodotorula bogoriensis, Wickerhamiella domercqiae, Wickerhamomyces anomalus and Starmerella bombicola and can be obtained from the fermentation of such microorganisms.

As stated at the outset, the compounds of general formula (I) are particularly suitable as components of cleaning agents, in particular liquid cleaning agents, due to their physical properties. Because of their high cleaning power, the amount of surfactant in such agents can be reduced while maintaining the same performance, or a smaller amount of the agent is needed to achieve a good cleaning result.

According to a preferred embodiment, a cleaning agent composition is described, wherein said composition contains the sophorolipid and the quaternary ammonium compound in a total amount of 0.1 wt. % to 40 wt. %, in particular 0.2 wt. % to 30 wt. % and particularly preferably 0.5 wt. % to 15 wt. %.

A cleaning agent is a composition which is suitable for cleaning and caring for hard surfaces and contains at least one surface-cleaning or surface-care active substance. Examples of surface-cleaning active substances are surfactants, in particular nonionic and anionic surfactants, and builders such as phosphonates or water-softening polymers. Examples of surface-care active substances are corrosion inhibitors, for instance zinc salts, and hydrophobizing agents, in particular polymeric hydrophobizing agents.

Where a cleaning agent composition is mentioned in connection with the present invention, in principle this means disinfecting cleaning agents for cleaning solid surfaces.

In the context of the present invention, the agent preferably additionally contains, in addition to the compound of general formula (I) or the above-defined mixture according to the invention, one or more substances from the group of nonionic surfactants, anionic surfactants, bleaching agents, bleach activators, enzymes, electrolytes, pH adjusters, perfumes, perfume carriers, fluorescing agents, dyes, hydrotropes, foam inhibitors, anti-redeposition agents, graying inhibitors, anti-shrink agents, anti-crease agents, dye transfer inhibitors, antimicrobial active ingredients, non-aqueous solvents, germicides, fungicides, antioxidants, preservatives, corrosion inhibitors, antistatic agents, bittering agents, ironing aids, repellents and impregnating agents, skin care active ingredients, anti-swelling and anti-slip agents, plasticizing components and UV absorbers.

According to a preferred embodiment, a cleaning agent composition is described wherein the cleaning agent composition is a liquid cleaning agent composition.

According to a further aspect, a method for cleaning hard surfaces is described wherein the cleaning agent composition according to one of the preceding claims is brought into contact with a hard surface to be cleaned.

A cleaning agent according to the invention can preferably contain up to 30 wt. % of additional surfactant, wherein any surfactants additionally present are preferably also obtained from renewable raw materials.

According to a preferred embodiment, a cleaning agent composition is described wherein said cleaning agent composition contains a nonionic surfactant.

In a particular embodiment of the invention, the agent contains up to 20 wt. %, in particular 0.5 wt. % to 15 wt. %, of nonionic surfactant.

Suitable nonionic surfactants include alkoxylated fatty acid alkyl esters, fatty acid amides, alkoxylated fatty acid amides, polyhydroxy fatty acid amides, alkylphenol polyglycol ethers, amine oxides, alkyl polyglucosides, and mixtures thereof. In addition, alkyl glycosides of the general formula R⁵O(G)ₓ can also be used as further nonionic surfactants, in which formula R⁵ is a primary straight-chain or methyl-branched, in particular methyl-branched at position 2, aliphatic functional group, having 8 to 22, preferably 12 to 18, C atoms, and G is the symbol to represent a glycose unit having 5 or 6 C atoms, preferably glucose. The degree of oligomerization x, which indicates the distribution of monoglycosides and oligoglycosides, is any number between 1 and 10; x is preferably between 1.2 and 1.4.

Another class of nonionic surfactants which are used either as the sole nonionic surfactant or in combination with other additional nonionic surfactants, are alkoxylated, preferably ethoxylated or ethoxylated and propoxylated, fatty acid alkyl esters, preferably having 1 to 4 carbon atoms in the alkyl chain.

Non-ionic surfactants of the aminoxide type, for example N-cocoalkyl-N,N-dimethylamine oxide and N-tallow-alkyl-N,N-dihydroxyethylamine oxide, and of the fatty acid alkanolamides may also be used.

Other suitable surfactants are polyhydroxy fatty acid amides of the formula,

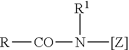

in which R represents an aliphatic acyl functional group having 6 to 22 carbon atoms, R¹ represents hydrogen, an alkyl or hydroxy alkyl functional group having 1 to 4 carbon atoms and [Z] represents a linear or branched polyhydroxyalkyl functional group having 3 to 10 carbon atoms and 3 to 10 hydroxyl groups. The polyhydroxy fatty acid amides are known substances that can usually be obtained by the reductive amination of a reducing sugar with ammonia, an alkyl amine or an alkanol amine, and subsequent acylation with a fatty acid, a fatty acid alkyl ester or a fatty acid chloride. The group of polyhydroxy fatty acid amides also includes compounds of the formula

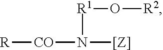

where R denotes a linear or branched alkyl or alkenyl group having 7 to 12 carbon atoms, R¹ denotes a linear, branched or cyclic alkyl group or an aryl group having 2 to 8 carbon atoms, and R² denotes a linear, branched or cyclic alkyl group or an aryl group or an oxy alkyl group having 1 to 8 carbon atoms, wherein C₁₋₄ alkyl or phenyl groups are preferred, and [Z] denotes a linear polyhydroxy alkyl group, the alkyl chain of which is substituted with at least two hydroxyl groups, or alkoxylated, preferably ethoxylated or propoxylated derivatives of this group. [Z] is preferably obtained by the reductive amination of a reduced sugar, for example glucose, fructose, maltose, lactose, galactose, mannose or xylose. The N-alkoxy- or N-aryloxy-substituted compounds can be converted into the desired polyhydroxy fatty acid amides by reaction with fatty acid methyl esters in the presence of an alkoxide as a catalyst.

Suitable peroxidic bleaching agents may be in particular organic peracids or peracid salts of organic acids, such as phthalimidopercaproic acid, perbenzoic acid, monoperoxyphthalic acid, and diperdodecane diacid and salts thereof, such as magnesium monoperoxyphthalate, diacyl peroxides, hydrogen peroxide and inorganic salts which release hydrogen peroxide under the conditions of use, such as alkali perborate, alkali percarbonate and/or alkali persilicate, and hydrogen peroxide inclusion compounds, such as H₂O₂ urea adducts, and mixtures thereof. Hydrogen peroxide can also be produced by means of an enzymatic system, i.e., an oxidase and the substrate thereof. If solid peroxygen compounds are intended to be used, these may be used in the form of powders or granules, which may also be coated in a manner known in principle. Particularly preferably, alkali percarbonate, alkali perborate monohydrate or hydrogen peroxide is used. A cleaning agent which can be used in the context of the invention contains peroxidic bleaching agent in amounts of preferably up to 60 wt. %, in particular of 5 wt. % to 50 wt. %, and particularly preferably of 15 wt. % to 30 wt. %, or alternatively of 2.5 wt. % to 20 wt. %, with hydrogen peroxide being the particularly preferred peroxidic bleaching agent in liquid agents and sodium percarbonate being the particularly preferred peroxidic bleaching agent in solid agents. Peroxidic bleaching agent particles preferably have a particle size in the range of 10 μm to 5,000 μm, in particular of 50 μm to 1,000 μm, and/or a density of 0.85 g/cm³ to 4.9 g/cm³, in particular of 0.91 g/cm³ to 2.7 g/cm³.

In particular, compounds which produce, under perhydrolysis conditions, optionally substituted perbenzoic acid and/or aliphatic peroxycarboxylic acids having 1 to 12 C atoms, in particular 2 to 4 C atoms, alone or in mixtures, are used as a bleach-activating compound that produces peroxycarboxylic acid under perhydrolysis conditions. Bleach activators that have O- and/or N-acyl groups in particular of the stated number of C atoms and/or optionally substituted benzoyl groups are suitable. Preference is given to polyacylated alkylenediamines, in particular tetraacetylethylenediamine (TAED), acylated glycolurils, in particular tetraacetylglycoluril (TAGU), acylated triazine derivatives, in particular 1,5-diacetyl-2,4-dioxohexahydro-1,3,5-triazine (DADHT), N-acylimides, in particular N-nonanoylsuccinimide (NOSI), acylated phenol sulfonates or carboxylates or the sulfonic or carboxylic acids thereof, in particular nonanoyl or isononanoyl or lauroyl oxybenzene sulfonate (NOBS or iso-NOBS or LOBS) or decanoyloxybenzoate (DOBA), the formal carbonic acid ester derivatives thereof such as 4-(2-decanoyloxyethoxycarbonyloxy)benzene sulfonate (DECOBS), acylated polyhydric alcohols, in particular triacetin, ethylene glycol diacetate and 2,5-diacetoxy-2,5-dihydrodrofuran and acetylated sorbitol and mannitol and mixtures thereof (SORMAN), acylated sugar derivatives, in particular pentaacetylglucose (PAG), pentaacetylfructose, tetraacetylxylose and octaacetyl lactose, acetylated, optionally N-alkylated glucamine and gluconolactone, and/or N-acylated lactams, for example N-benzoyl caprolactam.

In addition to, or instead of, compounds which form peroxycarboxylic acids under perhydrolysis conditions, other bleach activating compounds, such as nitriles, from which perimidic acids may form under perhydrolysis conditions, may be present. These include in particular aminoacetonitrile derivatives having a quaternized nitrogen atom according to the formula

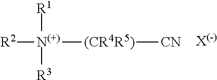

in which R¹ represents —H, —CH₃, a C₂₋₂₄ alkyl or alkenyl functional group, a substituted C₁₋₂₄ alkyl or C₂₋₂₄ alkenyl functional group having at least one substituent from the group of —Cl, —Br, —OH, —NH₂, —CN and —N⁽⁺⁾—CH₂—CN, an alkyl or alkenylaryl functional group having a C₁₋₂₄ alkyl group, or represents a substituted alkyl or alkenyl functional group having at least one, preferably two, optionally substituted C₁₋₂₄ alkyl groups and optionally further substituents on the aromatic ring, R² and R³ are independently selected from —CH₂—CN, —CH₃, —CH₂—CH₃, CH₂—CH₂—CH₃, —CH(CH₃)—CH₃, —CH₂—OH, —CH₂—CH₂—OH, —CH(OH)—CH₃, —CH₂—CH₂—CH₂—OH, —CH₂—CH(OH)—CH₃, —CH(OH)—CH₂—CH₃, —(CH₂CH₂—O)ₙH, where n=1, 2, 3, 4, 5 or 6, R⁴ and R⁵, independently of one another, have one of the definitions given above for R¹, R² or R³, wherein at least 2 of said functional groups, in particular R² and R³, also including the nitrogen atom and optionally other heteroatoms, can be linked to one another in a ring-closing manner and then preferably form a morpholino ring, and X is a charge-balancing anion, preferably selected from benzene sulfonate, toluene sulfonate, cumene sulfonate, the C₉₋₁₅ alkylbenzene sulfonates, the C₁₋₂₀ alkyl sulfates, the C₈₋₂₂ carboxylic acid methyl ester sulfonates, sulfate, hydrogen sulfate, and mixtures thereof, may be used. Bleach activators forming peroxycarboxylic acids or perimidic acids under perhydrolysis conditions are preferably present in agents according to the invention in amounts of up to 25 wt. %, in particular 0.1 wt. % to 10 wt. %. Bleach activator particles preferably have a particle size in the range of 10 μm to 5,000 μm, in particular of 50 μm to 1,000 μm, and/or a density of 0.85 g/cm³ to 4.9 g/cm³, in particular of 0.91 g/cm³ to 2.7 g/cm³.

The presence of bleach-catalyzing transition metal complexes, in addition to or instead of said bleach activators, is possible. These are preferably selected from the cobalt, iron, copper, titanium, vanadium, manganese and ruthenium complexes. Suitable ligands in such transition metal complexes include both inorganic and organic compounds, which include in particular, in addition to carboxylates, compounds having primary, secondary and/or tertiary amine and/or alcohol functions, such as pyridine, pyridazine, pyrimidine, pyrazine, imidazole, pyrazole, triazole, 2,2′-bispyridylamine, tris-(2-pyridylmethyl)amine, 1,4,7-triazacyclononane, 1,4,7-trimethyl-1,4,7-triazacyclononane, 1,5,9-trimethyl-1,5,9-triazacyclododecane, (bis-((1-methylimidazol-2-yl)-methyl))-(2-pyridylmethyl)amine, N,N′-(bis-(1-methylimidazol-2-yl)-methyl)ethylenediamine, N-bis-(2-benzimidazolylmethyl)aminoethanol, 2,6-bis-(bis-(2-benzimidazolylmethyl)aminomethyl)-4-methylphenol, N,N,N′,N′-tetrakis-(2-benzimidazolylmethyl)-2-hydroxy-1,3-diaminopropane, 2,6-bis-(bis-(2-pyridylmethyl)aminomethyl)-4-methylphenol, 1,3-bis-(bis-(2-benzimidazolylmethyl)aminomethyl)benzene, sorbitol, mannitol, erythritol, adonitol, inositol, lactose, and optionally substituted salens, porphins and porphyrins. The inorganic neutral ligands include in particular ammonia and water. If not all coordination sites of the transition metal central atom are occupied by neutral ligands, the complex contains further, preferably anionic, ligands, of these in particular mono- or bidentate ligands. These include in particular the halides such as fluoride, chloride, bromide and iodide, and the (NO₂)⁻ group, i.e., a nitro ligand or a nitrito ligand. The (NO₂)⁻ group may also be chelated to a transition metal or it may asymmetrically bridge or μ1-O-bridge two transition metal atoms. In addition to the ligands mentioned, the transition metal complexes may carry further, generally more simple ligands, in particular mono- or polyvalent anion ligands. For example, nitrate, acetate, trifluoroacetate, formate, carbonate, citrate, oxalate, perchlorate, and complex anions such as hexafluorophosphate are suitable. The anion ligands are intended to ensure charge balance between the transition metal central atom and the ligand system. The presence of oxo ligands, peroxo ligands and imino ligands is also possible. In particular, such ligands can also have a bridging effect, such that polynuclear complexes are produced. In the case of bridged, binuclear complexes, the two metal atoms in the complex do not need to be the same. The use of binuclear complexes in which the two transition metal central atoms have different oxidation numbers is also possible. If anion ligands are missing or the presence of anionic ligands does not result in charge balance in the complex, anionic counterions which neutralize the cationic transition metal complex are present in the transition metal complex compounds to be used according to the invention. These anionic counterions include in particular nitrate, hydroxide, hexafluorophosphate, sulfate, chlorate, perchlorate, the halides such as chloride or the anions of carboxylic acids such as formate, acetate, oxalate, benzoate or citrate. Examples of transition metal complex compounds that can be used are [N,N′-bis[(2-hydroxy-5-vinylphenyl)methylene]-1,2-diaminocyclohexane]manganese(III) chloride, [N,N′-bis[(2-hydroxy-5-nitrophenyl)methylene]-1,2-diaminocyclohexane]manganese(III) acetate, [N,N′-bis[(2-hydroxyphenyl)methylene]-1,2-phenylendiamine]manganese(III) acetate, [N,N′-bis[(2-hydroxyphenyl)methylene]-1,2-diaminocyclohexane]manganese(III) chloride, [N,N′-bis[(2-hydroxyphenyl)methylene]-1,2-diaminoethane]manganese(III) chloride, [N,N′-bis[(2-hydroxy-5-sulfonatophenyl)methylene]-1,2-diaminoethane]manganese(III) chloride, manganese oxalato complexes, nitropentamminecobalt(III) chloride, nitritopentamminecobalt(III) chloride, hexamminecobalt(III) chloride, chloropentamminecobalt(III) chloride and peroxo complex [(NH₃)₅Co—O—O—Co(NH₃)₅]Cl₄.

Enzymes from the class of proteases, amylases, lipases, cutinases, pullulanases, hemicellulases, cellulases, oxidases, laccases and peroxidases, and mixtures thereof are suitable as enzymes that can be used in the agents. Enzymatic active ingredients obtained from fungi or bacteria, such as Bacillus subtilis, Bacillus licheniformis, Bacillus lentus, Streptomyces griseus, Humicola lanuginosa, Humicola insolens, Pseudomonas pseudoalcaligenes, Pseudomonas cepacia or Coprinus cinereus are particularly suitable. The enzymes can be adsorbed on carrier substances and/or embedded in coating substances to protect the enzymes from premature inactivation. They are preferably contained in the cleaning agents according to the invention in amounts of up to 5 wt. %, in particular from 0.002 wt. % to 4 wt. %. If the agent according to the invention contains protease, it preferably has a proteolytic activity in the range of approximately 100 PE/g to approximately 10,000 PE/g, in particular 300 PE/g to 8,000 PE/g. If a plurality of enzymes is to be used in the agent according to the invention, this can be carried out by incorporation of the two or more separate enzymes or enzymes that have been separately manufactured in a known manner, or by two or more enzymes manufactured together in a granulate.

In order to set a desired pH that does not result automatically from mixing the other components, the agents according to the invention can contain acids that are compatible with the system and environment, in particular citric acid, acetic acid, tartaric acid, malic acid, lactic acid, glycolic acid, succinic acid, glutaric acid, and/or adipic acid, but also mineral acids, in particular sulfuric acid, or bases, in particular ammonium or alkali hydroxides. pH regulators of this kind are contained in the agents according to the invention in amounts of preferably no greater than 20 wt. %, in particular of 1.2 wt. % to 17 wt. %.

The function of graying inhibitors is to keep the dirt that is removed from the textile fibers suspended in the liquor. Water-soluble colloids, which are usually organic, are suitable for this purpose, for example starch, sizing material, gelatin, salts of ethercarboxylic acids or ethersulfonic acids of starch or of cellulose, or salts of acidic sulfuric acid esters of cellulose or of starch. Water-soluble polyamides containing acid groups are also suitable for this purpose. Starch derivatives other than those mentioned above may also be used, for example aldehyde starches. Cellulose ethers, such as carboxymethylcellulose (Na salt), methylcellulose, hydroxyalkylcellulose, and mixed ethers, such as methylhydroxyethylcellulose, methylhydroxypropylcellulose, methylcarboxymethylcellulose and mixtures thereof, are used, for example, in amounts of 0.1 to 5 wt. %, based on the agents.

If desired, the agents may contain a conventional dye transfer inhibitor, preferably in amounts of up to 2 wt. %, in particular 0.1 wt. % to 1 wt. %, which, in a preferred embodiment, is selected from the polymers of vinylpyrrolidone, vinylimidazole, vinylpyridine-N-oxide, or the copolymers thereof. Both polyvinylpyrrolidones having molecular weights of 15,000 g/mol to 50,000 g/mol and polyvinylpyrrolidones having higher molecular weights of, for example, up to more than 1,000,000 g/mol, in particular of 1,500,000 g/mol to 4,000,000 g/mol, N-vinylimidazole-N-vinylpyrrolidone copolymers, polyvinyloxazolidones, copolymers based on vinyl monomers and carboxylic acid amides, pyrrolidone-group-containing polyesters and polyamides, grafted polyamidoamines and polyethyleneimines, polyamine-N-oxide polymers and polyvinyl alcohols are suitable. However, it is also possible to use enzymatic systems comprising a peroxidase and hydrogen peroxide or a substance which produces hydrogen peroxide in water. The addition of a mediator compound for the peroxidase, for example an acetosyringone, a phenol derivative or a phenotiazine or phenoxazine, is preferred in this case, it also being possible to additionally use above-mentioned polymeric dye transfer inhibitor active ingredients. Polyvinylpyrrolidone preferably has an average molar mass in the range of 10,000 g/mol to 60,000 g/mol, in particular in the range of 25,000 g/mol to 50,000 g/mol. Of the copolymers, those consisting of vinylpyrrolidone and vinylimidazole in a mol ratio of 5:1 to 1:1 with an average molar mass in the range of 5,000 g/mol to 50,000 g/mol, in particular 10,000 g/mol to 20,000 g/mol, are preferred. In preferred embodiments of the invention, however, the cleaning agents are free of additional dye transfer inhibitors of this kind.

Cleaning agents may contain, for example, derivatives of diaminostilbenedisulfonic acid or the alkali metal salts thereof as optical brighteners, although they are preferably free of optical brighteners when used as color cleaning agents. Salts of 4,4′-bis(2-anilino-4-morpholino-1,3,5-triazinyl-6-amino)stilbene-2,2′-disulfonic acid or compounds having a similar structure which, instead of the morpholino group, have a diethanolamino group, a methylamino group, an anilino group or a 2-methoxyethylamino group are suitable, for example. Furthermore, brighteners of the substituted diphenylstyryl type may be present, for example the alkali salts of 4,4′-bis(2-sulfostyryl)diphenyl, 4,4′-bis(4-chloro-3-sulfostyryl)diphenyl, or 4-(4-chlorostyryl)-4′-(2-sulfostyryl)diphenyl. Mixtures of the aforementioned optical brighteners may also be used.

In a further preferred embodiment, an agent according to the invention is liquid and contains up to 90 wt. %, in particular 10 wt. % to 85 wt. %, preferably 25 wt. % to 75 wt. %, and particularly preferably 35 wt. % to 65 wt. %, water, water-miscible solvent, or a mixture of water and water-miscible solvent. Water-miscible solvents include, for example, monohydric alcohols having 1 to 4 C atoms, in particular methanol, ethanol, isopropanol and tert-butanol, diols and triols having 2 to 4 C atoms, in particular ethylene glycol, propylene glycol and glycerol, and mixtures thereof, and the ethers that can be derived from the classes of compounds mentioned. Water-miscible solvents of this kind are present in the agents according to the invention preferably in amounts of no greater than 30 wt. %, in particular of 2 wt. % to 20 wt. %. A liquid agent preferably has a pH of at least pH 5.6, in particular in the range of pH 7 to pH 9.

In a further preferred embodiment, the agent according to the invention is portioned ready for individual dosing in a chamber made of water-soluble material; the agent then contains preferably less than 15 wt. %, in particular in the range of 1 wt. % to 12 wt. %, water. A portion is an independent dosing unit having at least one chamber in which the product to be dosed is contained. A chamber is a space delimited by walls (e.g., by a film), which space can also exist without the product to be dosed (optionally by changing its shape). A surface coating or a layer of a surface coating is therefore not a wall according to the present invention.

The walls of the chamber are made of a water-soluble material. The water solubility of the material can be determined by means of a square film of said material (film: 22×22 mm with a thickness of 76 μm) fixed in a square frame (edge length on the inside: 20 mm) according to the following measurement protocol. Said framed film is submerged into 800 ml of distilled water, temperature-controlled to 20° C., in a 1 liter glass beaker with a circular base (Schott, Mainz, 1000 ml glass beaker, low shape), so that the surface of the tensioned film is arranged at a right angle to the base of the beaker, the upper edge of the frame is 1 cm below the water surface, and the lower edge of the frame is oriented parallel to the base of the glass beaker such that the lower edge of the frame extends along the radius of the base of the glass beaker and the center of the lower edge of the frame is arranged above the center of the radius of the glass beaker bottom. The material dissolves within 600 seconds when stirred (stirring speed magnet stirrer 300 rpm, stirring rod: 5 cm long), such that no solid particles at all can be seen with the naked eye.

The walls of the chambers and therefore the water-soluble wrappings of the cleaning agents according to the invention are preferably formed by a water-soluble film material. Water-soluble packages of this kind can be produced either by means of methods of vertical form fill sealing or by means of thermoforming methods.

The thermoforming method generally includes forming a first layer from a water-soluble film material in order to produce bulges for receiving a composition, pouring the composition into the bulges, covering the bulges filled with the composition with a second layer made of a water-soluble film material, and sealing the first and second layers to one another at least around the bulges.

The water-soluble film material is preferably selected from polymers or polymer mixtures. The wrapping may be made up of one or of two or more layers of water-soluble film material. The water-soluble film materials of the first layer and of the additional layers, if present, may be the same or different.

It is preferable for the water-soluble wrapping to contain polyvinyl alcohol or a polyvinyl alcohol copolymer; particularly preferably, it consists of polyvinyl alcohol or polyvinyl alcohol copolymer.

Water-soluble films for producing the water-soluble wrapping are preferably based on a polyvinyl alcohol or a polyvinyl alcohol copolymer of which the molecular weight is in the range of 10,000 to 1,000,000 gmol⁻¹, preferably of 20,000 to 500,000 gmol⁻¹, particularly preferably of 30,000 to 100,000 gmol⁻¹, and in particular of 40,000 to 80,000 gmol⁻¹.

Polyvinyl alcohol is usually prepared by hydrolysis of polyvinyl acetate, since the direct synthesis route is not possible. The same applies to polyvinyl alcohol copolymers, which are prepared accordingly from polyvinyl acetate copolymers. It is preferable for at least one layer of the water-soluble wrapping to include a polyvinyl alcohol of which the degree of hydrolysis is 70 to 100 mol. %, preferably 80 to 90 mol. %, particularly preferably 81 to 89 mol. %, and in particular 82 to 88 mol. %.

Polymers selected from the group comprising acrylic acid-containing polymers, polyacrylamides, oxazoline polymers, polystyrene sulfonates, polyurethanes, polyesters, polyethers, polylactic acid, and/or mixtures of the above polymers may additionally be added to a film material suitable for producing the water-soluble wrapping. It is also possible to copolymerize such monomers on which the polymers are based, individually or in mixtures of two or more, with vinyl acetate.

Preferred polyvinyl alcohol copolymers comprise, in addition to vinyl alcohol, an ethylenically unsaturated carboxylic acid, or the salt or ester thereof. Polyvinyl alcohol copolymers of this kind particularly preferably contain acrylic acid, methacrylic acid, acrylic acid ester, methacrylic acid ester or mixtures thereof, in addition to vinyl alcohol; of the esters, C₁₋₄ alkyl esters or C₁₋₄ hydroxyalkyl esters are preferred. Polyvinyl alcohol copolymers which include, in addition to vinyl alcohol, ethylenically unsaturated dicarboxylic acids as further monomers are also preferred. Suitable dicarboxylic acids are, for example, itaconic acid, maleic acid, fumaric acid, and mixtures thereof, itaconic acid being particularly preferred.

Suitable water-soluble films for use in the wrappings of the water-soluble packaging according to the invention are films which are sold by MonoSol LLC, for example under the names M8630, C8400 or M8900. Other suitable films include films with the name Solublon® PT, Solublon® GA, Solublon® KC or Solublon® KL by Aicello Chemical Europe GmbH or the VF-HP films by Kuraray.

The cleaning agent portion comprising the cleaning agent and the water-soluble wrapping may have one or more chambers. The water-soluble wrappings having a chamber can have a substantially dimensionally stable spherical, rotationally ellipsoidal, cubic, cuboidal or pillow-shaped design with a circular, elliptical, square or rectangular basic shape. The agent may be contained in one or more chambers, if present, of the water-soluble wrapping.

In a preferred embodiment, the water-soluble wrapping has two chambers. In this embodiment, the two chambers may each contain a solid partial composition or a liquid partial composition, or the first chamber contains a liquid partial composition and the second chamber a solid partial composition.

The proportions of the agents contained in the different chambers of a water-soluble wrapping having two or more chambers may have the same composition. Preferably, however, the agents in a water-soluble wrapping having at least two chambers have partial compositions which differ by at least one ingredient and/or by the content of at least one ingredient. Preferably, a partial composition of such agents according to the invention comprises an enzyme and/or a bleach activator and a separate further partial composition comprises peroxidic bleaching agent, the first partial composition thus in particular not comprising peroxidic bleaching agent and the second partial composition in particular not comprising an enzyme or a bleach activator.

Liquid or pasty agents according to the invention in the form of solutions typically containing water solvents are usually prepared by simple mixing of the ingredients, which can be put into an automatic mixer in bulk or as a solution.

### EXAMPLES

In the procedure, a white dirt carrier treated with test dirt is wiped with a sponge soaked in the test specimen under defined conditions. The cleaning performance is measured photoelectrically against an untreated white dirt carrier (=100% whiteness). The basic principles of the test procedure were published in 1986 as quality standards in the magazine “Seifen-Ole-Fette-Wachse”, 112th Volume, Issue 10, pages 371-372.

| Example | | % Whiteness | % Dirt removal |
|---|---|---|---|
| C1 | | 35.5 | 48.5 |
| C2 | +0.1% | 36.5 | 49.8 |
| | Sophorolipid and | | |
| | no BAC | | |
| E1 | BAC + 0.1% | 40.6 | 55.4 |
| | Sophorolipid | | |
| E2 | BAC + 0.2% | 43.1 | 58.8 |
| | Sophorolipid | | |

The reference formula is a regular disinfectant formulation containing only 0.6 wt. % BAC and 0.5 wt. % nonionic fatty alcohol ethoxylate (comprising 0.25% AS Lutensol XL 70-C10-Guerbet alcohol alkoxylate+7 EO and 0.25% AS Galaxy MW 287-Lauryl Alcohol Ethoxylate-7 mol).

Formula II contains a sophorolipid (without BAC) in addition to the nonionic fatty alcohol ethoxylate, and does not show any significant advantage over the reference formula. This changes when mixtures of BAC and sophorolipids are introduced, as seen with E1 and E2, which provide >5% more dirt removal and are therefore above the required significance threshold.

Surprisingly, it was thus found that the addition of an antimicrobial active ingredient (BAC) significantly improved the cleaning performance of sophorolipid surfactants.

1. A cleaning agent composition for cleaning hard surfaces, the cleaning agent composition comprising:
a sophorolipid; and
an antimicrobial agent comprising a quaternary ammonium compound,
wherein the quaternary ammonium compound has the formula (I): 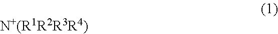
wherein the quaternary ammonium compound of formula (I) has:
two functional groups having a C-chain length of at most four, and
at least one functional group having a C₈ to C₁₈ carbon chain.

2. The cleaning agent composition of claim 1, wherein the antimicrobial agent is a benzalkonium halide.

3. The cleaning agent composition of claim 1, wherein the antimicrobial agent is a didecyldimethylammonium halide.

4. The cleaning agent composition of claim 1, wherein the sophorolipid and the quaternary ammonium compound are in an amount of from 0.1 wt. % to 40 wt. %, based on the total weight of the cleaning agent composition.

5. The cleaning agent composition of claim 1, further comprising a nonionic surfactant.

6. The cleaning agent composition of claim 5, wherein the nonionic surfactant is in an amount of said up to 20 wt. %, based on the total weight of the cleaning agent composition.

7. The cleaning agent composition of claim 1, wherein the quaternary ammonium compound is in an amount of from 0.001 wt. % to 10 wt. %, based on the total weight of the cleaning agent composition.

8. The cleaning agent composition of claim 1, wherein the cleaning agent composition is a liquid cleaning agent composition.

9. A method for cleaning hard surfaces, the method comprising applying the cleaning agent composition of claim 1 to a hard surface.

10. The cleaning agent composition of claim 1, wherein the two functional groups of the quaternary ammonium compound of formula (I) have a C-chain length of one.

11. The cleaning agent composition of claim 1, wherein the at least one functional group of the quaternary ammonium compound of formula (I) comprises two functional groups having a C₈ to C₁₈ carbon chain.

12. The cleaning agent composition of claim 1, wherein the at least one functional group of the quaternary ammonium compound of formula (I) comprises at least one functional group having a C₁₂ carbon chain.

13. The cleaning agent composition of claim 1, wherein the quaternary ammonium compound of formula (I) further has a functional group having a benzyl group.

14. The cleaning agent composition of claim 2, wherein the benzalkonium halide is benzalkonium chloride.

15. The cleaning agent composition of claim 3, wherein the didecyldimethylammonium halide is didecyldimethylammonium chloride.

16. The cleaning agent composition of claim 4, wherein the sophorolipid and the quaternary ammonium compound are in an amount of from 0.2 wt. % to 30 wt. %, based on the total weight of the cleaning agent composition.

17. The cleaning agent composition of claim 16, wherein the sophorolipid and the quaternary ammonium compound are in an amount of from 0.5 wt. % to 15 wt. %, based on the total weight of the cleaning agent composition.

18. The cleaning agent composition of claim 6, wherein the nonionic surfactant is in an amount of from 0.1 wt. % to 5 wt. %, based on the total weight of the cleaning agent composition.

19. The cleaning agent composition of claim 7, wherein the quaternary ammonium compound is in an amount of from 0.01 wt. % to 5 wt. %, based on the total weight of the cleaning agent composition.

20. The cleaning agent composition of claim 19, wherein the quaternary ammonium compound is in an amount of from 0.01 wt. % to 2 wt. %, based on the total weight of the cleaning agent composition.
